(19) United States
(12) Patent Application Publication
(10) Pub. No.: US 2026/0268923 A1
(43) Pub. Date: Sep. 10, 2026

(54) GLOTTAL FEATURES EXTRACTION USING NEURAL NETWORKS

(71) Applicant: THE PROVOST, FELLOWS, SCHOLARS AND OTHER MEMBERS OF BOARD OF TRINITY COLLEGE DUBLIN, Dublin (IE)

(72) Inventor: Joäo Paulo Cabral, Dublin (IE)

(21) Appl. No.: 18/875,668

(22) PCT Filed: Jun. 19, 2023
(86) PCT No.: PCT/EP2023/066506

§ 371 Date: Dec. 16, 2024

(30) Foreign Application Priority Data
Jun. 17, 2022 (GB) 2208937.9

(51) Int. Cl. G10L 25/30; G10L 13/02; G10L 25/03; G10L 25/66

(52) U.S. Cl. CPC G10L 25/30; G10L 13/02; G10L 25/03; G10L 25/66

(57) ABSTRACT

Disclosed is a method for predicting acoustic features including glottal parameters of an acoustic glottal source model that includes extracting one or more glottal parameters from one or more input signals containing information about glottal source signal, using a deep neural network (NN), wherein the NN is trained using one or more input signals, and previously estimated glottal parameters.

### FIELD

The disclosure relates to glottal features extraction, and more particularly to extracting glottal features of a glottal source model using neural networks.

### BACKGROUND

FIG. 1A illustrates a typical speech waveform and a corresponding glottal source waveform produced by a speaker. The glottal features are strongly correlated with emotions and the type of voice, enabling to produce higher-quality speech and better transformation of expressive speech compared with synthesis systems that do not use glottal features. However, there does not exist an analytical solution to separate the glottal source and vocal tract components from the speech signal due to the problem of calculating multiple unknown variables such as vocal tract, glottal signal, noise component, etc. from a single signal (the speech signal).

Presently, the methods to estimate glottal source parameters of an acoustic glottal source model, such as the parametric Liljencrants-Fant model (LF-model), are based on signal processing. FIG. 1B illustrates the LF-model 102 which is a popular glottal source model, that is defined by a small set of acoustic parameters. The parameters consist of time instants and amplitudes. The LF-model 102 represents the derivative of the glottal source signal, such that the integrated LF-model waveform 104 approximates the glottal pulses. However, the methods to estimate the glottal source parameters rely on assumptions, for example, the simplification of linear source-filter model, or that the glottal source and vocal tract are independent. That is, they generally assume that speech can be produced by passing the glottal source signal through a linear filter representing the vocal tract, and as a result, they are not robust and accurate enough.

The accuracy of glottal parameter estimation can be improved by using additional measurements and semi-automatic methods that require human intervention to verify and correct the parameter estimates. This manual intervention limits the application of glottal source estimation on large speech datasets.

As illustrated in FIG. 2, one way to obtain more reliable glottal parameter estimation is to use the human-in-the-loop approach. Initial estimates can be obtained using automatic signal processing algorithms. Then, the resulting estimates may be manually verified and corrected by observing a signal representing the relevant characteristics of the glottal source signal and the respective estimated parameters of the glottal source model or the synthesised version of the glottal model. These estimates may be further refined with another cycle of automatic signal processing estimation of the glottal parameters and eventually followed by human verification and correction. However, this semi-automatic process of estimating the glottal parameters is very time consuming due to the need of human intervention.

WO2008018653 discloses the extraction of various time periods of the glottal wave under an LF model of the derivative glottal wave in order to generate a synthesised voice. Said document refers to using a neural network for voice conversion, and discloses the step of extracting glottal wave from voice signal, extracting parameters from the extracted glottal wave, and converting the parameters extracted from the glottal wave of an original speaker into the parameters of a target speaker. However, the method to estimate the LF-model parameters is based on a signal processing algorithm to fit the glottal derivative waveform to the LF-model waveform, which is not accurate and robust enough.

WO2020062217 discloses a neural network that is used to generate the speech waveform from acoustic features including glottal parameters. Said document indicates that the glottal features, the vocal tract features and the fundamental frequency may be generated based on the input signal through various suitable manners and refers to signal processing techniques. However, said signal processing techniques are not accurate and robust enough.

WO2020/062217 discloses generating a glottal waveform based on the fundamental frequency information and the glottal features through a neural network model. However, the neural network has been trained to predict the glottal waveform from input glottal features that are estimated using signal processing techniques, which are known to produce estimation errors. These errors have a negative effect in the prediction capacity of the network to generate the correct glottal waveform signal which in turn may deteriorate the quality of the synthetic speech.

In view of the above, there is a need for a system and method for accurately estimating the glottal parameters that is better than using traditional signal processing techniques, does not require human intervention, as is efficient and is not time consuming.

### SUMMARY OF THE INVENTION

In an aspect of the present invention, there is provided a method for predicting acoustic features including one or more glottal parameters of an acoustic glottal source model, as set out in the appended claims. The method comprises extracting acoustic features including one or more glottal parameters from an input signal containing information about glottal source signal, using a neural network (NN), wherein the NN is trained using one or more input signals, and previously estimated glottal parameters.

In an embodiment of the present invention, the acoustic glottal source model is an Liljencrants-Fant model (LF-model), and the NN estimates one or more parameters defining the LF-model, and wherein the NN is trained to estimate durations of the input signal to enable determination of time domain parameters tₚ, tₑ, tₐ, t_{c}, T₀ of the LF-model.

In an embodiment of the present invention, the input to the NN includes one or multiple signals from the following: a speech signal, a signal containing information about glottal source, an EGG signal, an estimate of the glottal source signal obtained from the speech signal by using an inverse filtering technique, an estimate of the glottal source signal obtained using a neural network, and an estimate of the glottal source signal obtained from an input text.

In an embodiment of the present invention, the method further includes extracting by the NN, a plurality of shape parameters Open Quotient (OQ), Speed Quotient (SQ), and Return Quotient (RQ) of the LF model from the input signal.

In an embodiment of the present invention, the method further includes determining by the NN, one or more time-domain parameters of the LF-model tₚ, tₑ, tₐ, t_{c}, T₀ from the plurality of shape parameters, Open Quotient (OQ), Speed Quotient (SQ), and Return Quotient (RQ).

In an embodiment of the present invention, the method further includes extracting vocal tract (VT) parameters, and residual parts including noise and non-linear parameters from the input signal.

In an embodiment of the present invention, the method further includes synthesizing speech using the estimated parameters of the acoustic glottal source model by first generating the glottal source waveform using the predicted glottal parameters, mixing the generated signal with a noise component generated by noise parameters and convolving the mixed-excitation signal with the VT transfer function defined by the VT parameters.

In an embodiment of the present invention, the method further includes automatically diagnosing speech disorders in a speech signal using the estimated glottal parameters.

In an embodiment of the present invention, the method further includes synthesizing speech using the estimated glottal parameters as input to a neural vocoder that is trained to reconstruct a speech waveform from a set of speech features.

In an embodiment of the present invention, the glottal closure instant (GCI) parameter tₑ is estimated based on one or more lowest amplitude peaks of the derivative of the EGG signal using a peak detection algorithm.

In an embodiment of the present invention, the pitch period T₀ is calculated as the duration between consecutive glottal closure instants tₑ of the derivative of the EGG signal.

In an embodiment of the present invention, the NN is configured to synthesise speech from input text using the one or more glottal parameters, wherein the one or more glottal parameters condition the prediction of the speech waveform and transform one or more acoustic properties of the speech waveform.

In another aspect of the present invention, there is provided a system for predicting acoustic features including one or more glottal parameters of an acoustic glottal source model. The system includes a processing unit, a non-transitory memory means operably coupled to the processing unit, the memory means has a plurality of instructions stored thereon which configures the processing unit to extract one or more glottal parameters from an input signal containing information about glottal source signal, using a neural network (NN), wherein the NN is trained using a plurality of input signals, and previously estimated glottal parameters.

There is also provided a computer program comprising program instructions for causing a computer program to carry out the above method which may be embodied on a record medium, carrier signal or read-only memory.

Various embodiments of the present invention facilitate estimating the acoustic features including one or more glottal parameters independently using the neural network from speech and/or EGG signals. Then, the estimated glottal parameters are used together with other speech features to train a NN-based speech synthesis system. The application of the innovative method is to use glottal parameters in a speech synthesis system.

As compared to existing systems, the present invention explicitly uses a well-known acoustic glottal source model, called LF-model, instead of using a neural vocoder to generate the glottal source signal. The advantage of using the LF-model is that the prediction of the glottal signal is much less computationally complex, and its parameters can be controlled to transform voice characteristics and expressiveness unlike with the neural vocoder. Also, the LF-model, which enables the control over voice parameters that are correlated with different voice styles, such as breathy, tense and creaky voices. This makes it easy to manually tune the voice parameters to produce different synthetic voice styles.

The present invention discloses extracting glottal parameters from input signals using a neural network, as compared to using signal processing techniques for generating the glottal features, the vocal tract features and the fundamental frequency. In the present invention, the input signal is glottal waveform or other type of waveform and the output are the acoustic features, including the glottal features.

### BRIEF DESCRIPTION OF THE DRAWINGS

The invention will be more clearly understood from the following description of an embodiment thereof, given by way of example only, with reference to the accompanying drawings, in which:—

FIG. 1A illustrates a typical speech waveform and a corresponding glottal source waveform produced by a speaker;

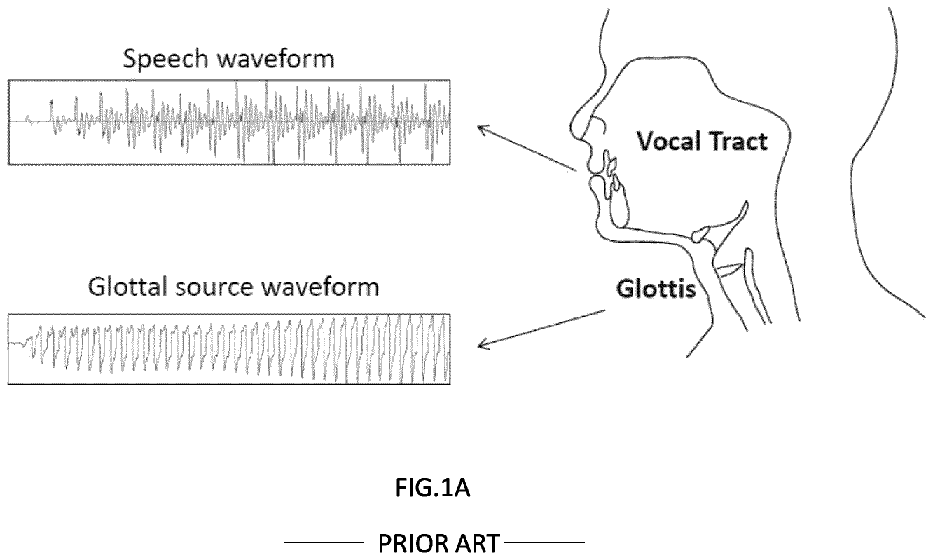

FIG. 1B illustrates the LF-model, that is defined by a small set of acoustic parameters;

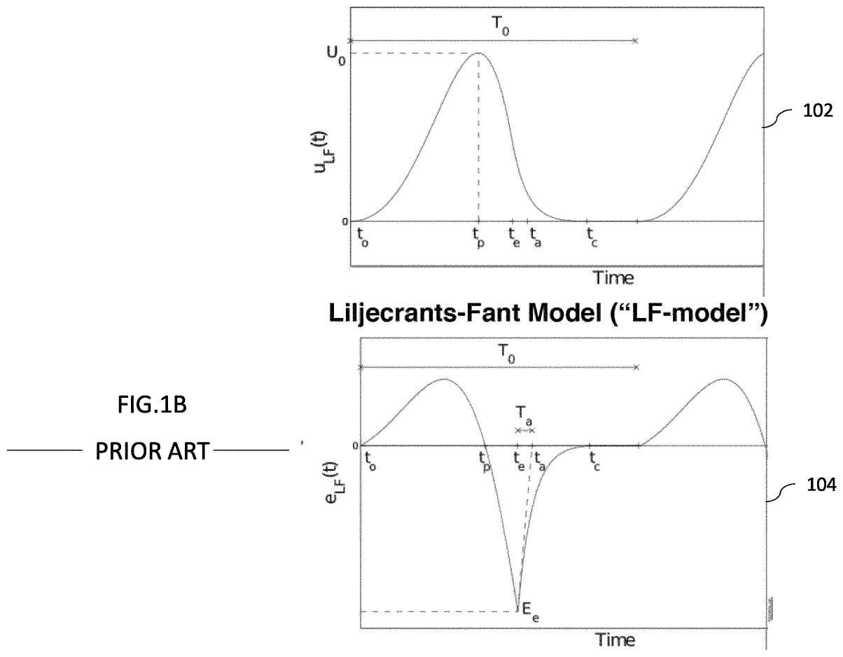

FIG. 2 illustrates a conventional method for estimating glottal source parameters;

FIG. 3 illustrates a system for estimating glottal source parameters, in accordance with an embodiment of the present invention;

FIG. 4 illustrates the use of a Neural Network (NN) for estimating glottal source parameters, in accordance with an embodiment of the present invention;

FIG. 5A illustrates a text-to-speech synthesis system that uses a NN in accordance with an embodiment of the present invention;

FIG. 5B illustrates an end-to-end Text-to-Speech Synthesis system without the vocoder component, that uses a NN in accordance with an embodiment of the present invention;

FIG. 6(A) illustrates an example of the glottal parameter tₑ of the LF-model estimated from the derivative of the EGG signal using a peak detection algorithm;

FIG. 6(B) illustrates a segment of the derivative of the EGG signal recorded for a spoken sentence and the parameter tₑ of the LF-model, estimated using the peak detection algorithm;

FIG. 7 shows opening instants obtained with two versions of peak detection algorithm, in accordance with an embodiment of the present invention;

FIG. 8 illustrates examples of the LF-model parameters estimated from the speech signal using signal processing techniques;

FIG. 9 illustrates an example of a neural network that is trained to predict the regions of the glottal pulse, in accordance with an embodiment of the present invention;

FIG. 10 illustrates an example of the input signal to the neural network, and the durations of the Open Phase (OP) and Closed Phase (CL) measured on the input signal using signal processing methods; and

FIG. 11 shows an example of the DEGG waveform and the durations of the OP and CL, predicted by the neural network after training;

### DETAILED DESCRIPTION OF THE DRAWINGS

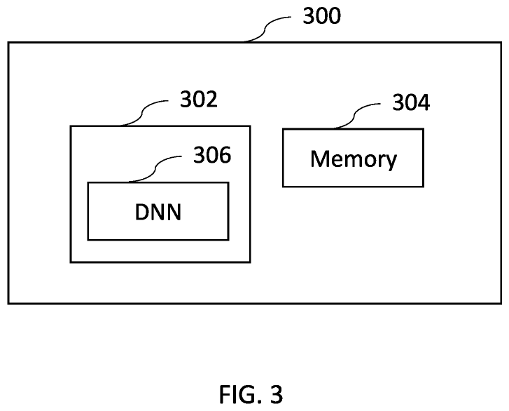

FIG. 3 is a block diagram of a system 300 for estimating acoustic features including one or more glottal parameters of an acoustic glottal source model, in accordance with an embodiment of the present invention.

The system 300 includes a processor 302 and a non-transitory memory 304 operably coupled to the processor 302. In the context of the present invention, the processor 302 may represent a computational platform that includes components that may be in a server or another computer system, and execute, by way of a processor (e.g., a single or multiple processors) or other hardware described herein. These methods, functions and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). Based on the instructions stored in the non-transitory memory 304, the processor 302 runs a Neural Network (NN) 306 to estimate glottal source parameters of an acoustic glottal source model.

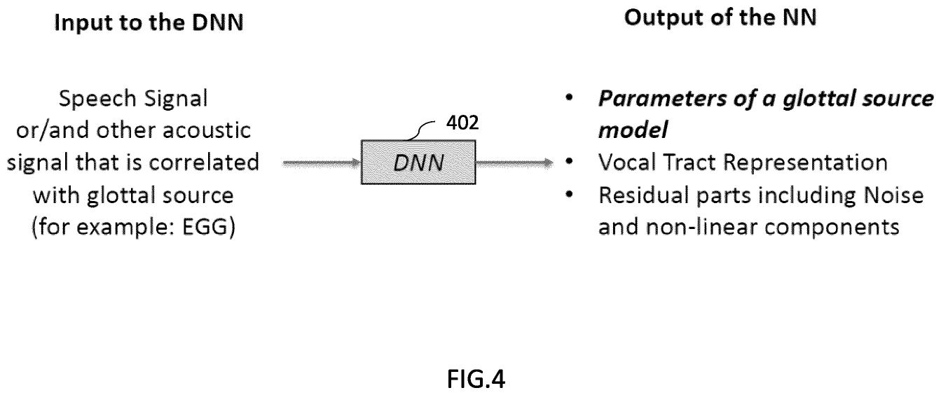

FIG. 4 illustrates the use of a NN 402 for estimating glottal source parameters, in accordance with an embodiment of the present invention. The NN 402 is a non-linear model that has the potential to represent well non-linear functions. That is a great advantage of NN 402 over other machine learning algorithms and signal processing techniques. For example, it has been demonstrated that any function can be approximated to arbitrary accuracy by a network with two hidden layers. The input to the NN 402 includes a speech signal, and/or other acoustic signal that contains information about glottal source signal. The NN 402 is not constrained to use the speech signal as input. An example of such acoustic signal is EGG, or an estimate of the glottal source signal obtained from the speech signal by using an adaptive inverse filtering technique. The output of the NN 402 mainly includes parameters of a glottal source model. Other output of the NN 402 includes vocal tract representation, and residual parts including noise and non-linear components.

The NN 402 estimates the glottal parameters from one or more input representations that contain information about the glottal source signal. For example, these representations can be the speech signal, an approximation of the glottal source signal obtained from the speech signal or a signal that contains information about the glottal source, such as the signal measured by an Electroglottograph (measures the vocal fold activity). A popular measure to extract information about glottal source is the signal measured by Electroglottography (EGG). The Electroglottograph signal does not represent directly the glottal source signal, but can be used to estimate more accurately some glottal source parameters, particularly pitch.

The dataset used to train the NN 402 includes the input signal representations and accurate estimates of the glottal parameters. These parameter estimates may be obtained using a conventional semi-automatic glottal parameter estimation method.

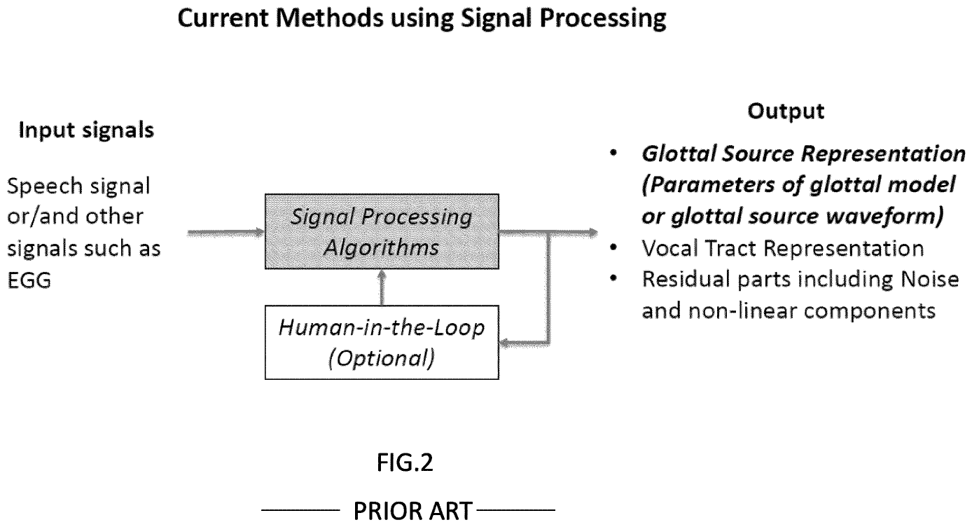

One inventive step of the present invention is using the NN 402 to estimate parameters of a glottal source model from an input speech. For example, the glottal source model can be the LF model. In the case of using the LF model, the NN 402 estimates five time-domain parameters tₚ, tₑ, tₐ, t_{c}, T₀ and an amplitude parameter Eₑ from the speech signal. Analytically, the LF-model is defined by an exponentially increasing sine wave, followed by a decaying exponential function, and completed with a zero-amplitude section, as described by the following equations:

$$e ( t ) = \{ \begin{matrix}{E}_{0} {e}^{α t} sin ( t π / {t}_{p} ) , & {t}_{0} \leq t \leq {t}_{e} \\ - \frac{{E}_{e}}{ε {t}_{a}} [ {e}^{- ε ( t - {t}_{e} )} - {e}^{- ε ( {t}_{c} - {t}_{e} )} ] , & {t}_{e} < t \leq {t}_{c} \\ 0 , & {t}_{c} < t \leq {T}_{0}\end{matrix}$$

where the LF-model parameters represent the following characteristics of the flow derivative waveform (see FIG. 2):

tₒ: instant of glottal opening, when the vocal folds start to open.

tₚ: instant of maximum flow, which corresponds to a zero of the flow derivative.

tₑ: instant of maximum excitation, when the vocal folds close abruptly.

tₐ: instant when the tangent to the decaying exponential at t=tₑ hits the time axis

t_{c}: instant of complete closure of the vocal folds.

T₀: duration of the glottal flow cycle (fundamental period, also called pitch period).

Eₑ: amplitude of maximum excitation.

E₀: amplitude scaling of the sine wave.

α: growth factor, which represents the ratio of Eₑ to the peak height of the exponentially increasing sine wave, E₀.

ε: exponential time constant.

The region between the start of the glottal pulse and the instant of maximum airflow, is called the opening phase and has duration Tₒₚ=tₑ−tₒ. At the instant of maximum excitation, tₑ, occurs an abrupt closure of the vocal folds (discontinuity in the derivative of the LF-model). The next part represents the transition between the open phase and the closed phase, which is called return phase. The duration of the return phase is given by Tₐ=tₐ−tₑ and it measures the abruptness of the closure. Finally, the closed phase is the region of the glottal cycle when the vocal folds are completely closed and it has duration T_{c}=T₀−t_{c}. The value of the parameter tₒ is arbitrary, as it represents the start of the LF-model (to can be assumed to be zero). It is common to use a simplification of the LF-model that defines T_{c}=T₀−tₑ and just uses the first two equations to define e(t), in which the second is defined for tₑ<t≤T₀. In the text of this document, the closed phase is defined as T_{c}=T₀−tₑ. The remaining parameters (ε and α, and E₀) are calculated using the energy and continuity constraints, respectively:

$${\int }_{0}^{{T}_{0}} {e}_{LF} ( t ) dt = 0$$

$${e}_{1} ( {t}_{e} ) = {e}_{2} ( {t}_{e} ) = - {E}_{e}$$

It is to be noted that the eLF (t) is the same as e(t) in the previous equation. Also, e₁(t) represents the first equation in the system of equations presented above, while e₂(t) represents the second equation in the previous system of equations.

The above-mentioned estimated glottal parameters may be used to generate a glottal source waveform, hereafter also referred to as glottal source signal. The glottal source waveform may be generated from the parameters outputted by the NN 402, using the equations that define the LF-Model and were presented earlier.

It is to be noted that the NN 402 is configured to estimate the time-domain LF-parameters and not shape parameters of a glottal source model. In an example, the LF-model can also be represented by shape parameters, which may be obtained from time domain LF parameters based on the following equations:

$$OQ = \frac{{t}_{e} + {t}_{a}}{{T}_{0}}$$

$$SQ = \frac{{t}_{p}}{{t}_{e} - {t}_{p}}$$

$$RQ = \frac{{t}_{a}}{{T}_{0}}$$

These parameters are called Open Quotient (OQ), Speed Quotient (SQ), and Return Quotient (RQ). The shape parameters of the glottal source model defined above are important because they are correlated with different voice styles, e.g. breathy and tense voices. They are also related with speech emotions. The advantage of modelling these parameters in a Text-to-Speech System is to improve parametric controllability by the user to transform the synthetic voice styles and emotions.

The state-of-the-art Text-to-Speech Synthesis (TTS) systems that produce the best quality use neural vocoders, take raw spectrograms as input, and generate the speech waveform.

It is to be noted that existing Text to Speech Synthesis (TTS) methods typically model the Fundamental Frequency (the inverse of the pitch period: F₀=1/T₀), to provide control over the pitch of synthetic speech. It is uncommon to model the other glottal parameters of the LF-model, besides T₀. The advantage of modelling additional glottal parameters is to provide additional flexibility to control voice characteristic of the synthetic speech. For example, to change the voice in the lax-tense continuum, in addition to pitch. The Deep Neural Network (DNN) based algorithms of the present invention may significantly accelerate the process of accurate estimation of the glottal parameters by avoiding the human-in-the-loop approach.

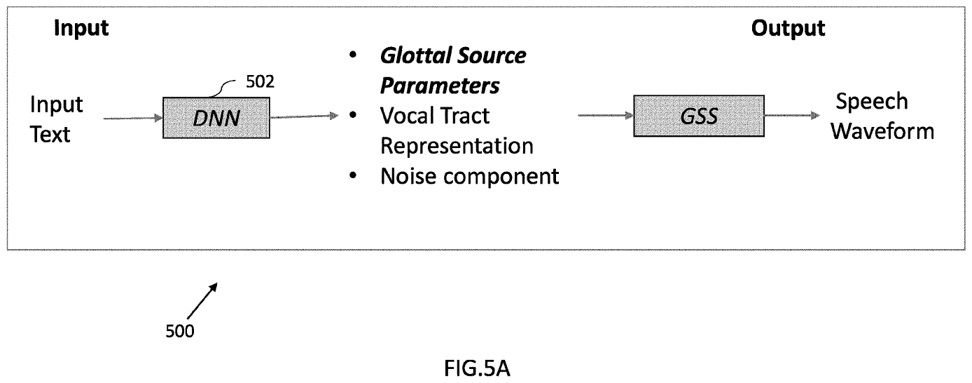

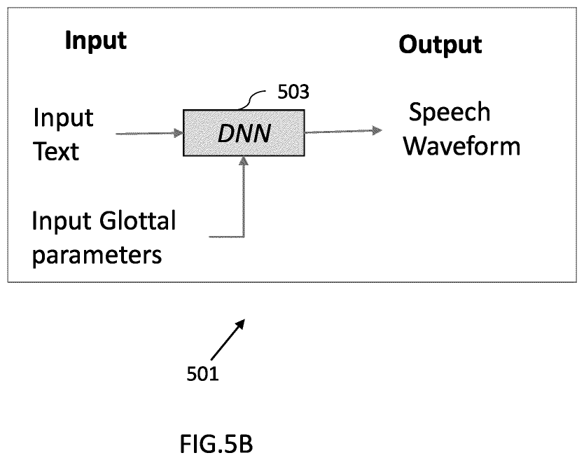

FIG. 5A illustrates a text-to-speech synthesis system 500 that uses another NN 502 in accordance with an embodiment of the present invention. The NN 502 is trained to predict the glottal source, noise, and vocal tract (VT) parameters from the input text. These parameters may be then used to generate the speech waveform using the analysis-synthesis method called Glottal Spectral Separation (GSS). The GSS is a signal processing method which is used for analysis-synthesis of a speech signal, however, in this example, only the synthesis part of GSS is used. Basically, the GSS generates the LF-model waveform using the glottal parameters. Then, it mixes the periodic component of the LF-model with a noise signal generated from the noise parameters. Finally, it convolves the resulting mixed-excitation signal with the Vocal Tract Transfer function defined by the VT parameters. The synthesis algorithm of GSS is fast, has very low memory requirements and can produce speech at a speed comparable to real-time, making it suitable for embedded solutions in mobile devices.

FIG. 5B illustrates a text-to-speech synthesis (TTS) system 501 that uses another NN 503 in accordance with an embodiment of the present invention. The NN 503 is trained to predict the speech waveform from input text without using an explicit vocoder component. That is, the TTS system 501 belongs to the type of systems called end-to-end TTS, which use a single NN model without a need to use a vocoder/GSS. The NN 503 is trained to synthesise speech from input text but can also use input glottal parameters to condition the prediction of the speech waveform and transform acoustic properties such as voice style and emotions. For example, glottal parameters can also be provided as input to the NN to allow to transform voice characteristics by controlling these input parameters. During training of the NN 503, the input glottal parameters can be estimated using a system for estimating glottal source parameters, in accordance with an embodiment of the present invention (represented in FIGS. 3 and 4).

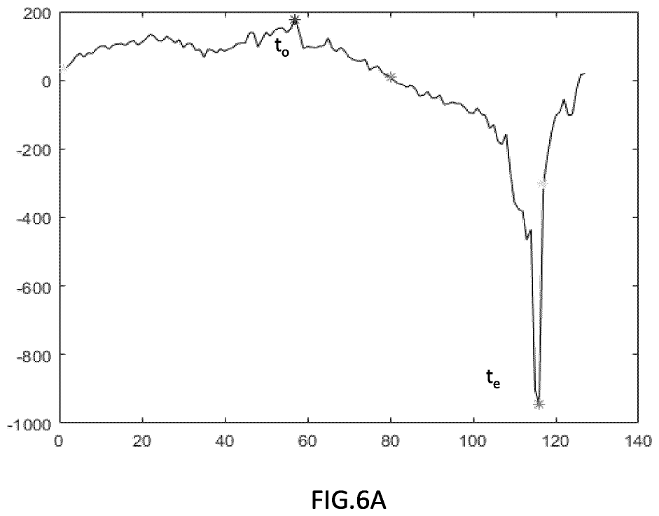

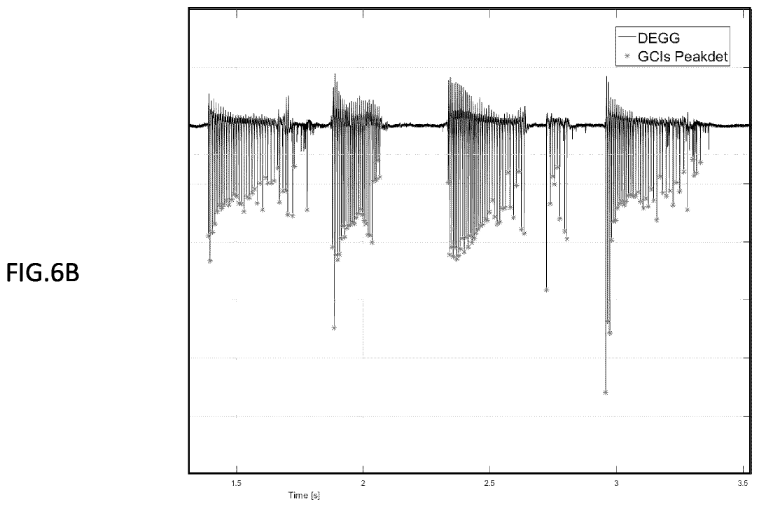

FIG. 6(A) illustrates an example of the glottal parameter tₑ of the LF-model estimated from the derivative of the EGG signal using a peak detection algorithm. The parameter tₑ is called the glottal closure instant (GCI). FIG. 6(B) illustrates a segment of the derivative of the EGG signal measured for a spoken sentence and the parameter tₑ of the LF-model, estimated using the peak detection algorithm. Basically, this algorithm detects the lowest amplitude peaks in the waveform.

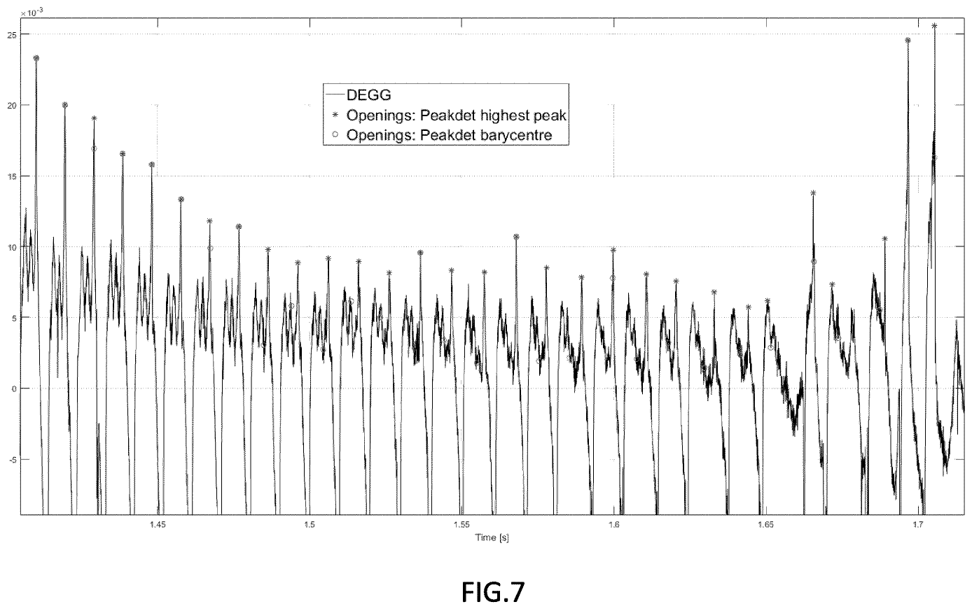

FIG. 7 illustrates an example of the glottal parameter tₒ of the LF-model estimated from the derivative of the EGG signal using the peak detection algorithm. For each DEGG cycle, the waveform often has multiple amplitude peaks and there are multiple options available in the Peakdet algorithm to detect the peaks. FIG. 7 shows opening instants obtained with two versions of this peak detection algorithm, one that detects the highest peak and the other that estimates the parameter as the barycentre of the peaks.

It is to be noted that from the EGG signal, it is only possible to estimate tₑ and T₀. The other parameters of the LF-model may be estimated from the speech signal using signal processing algorithms.

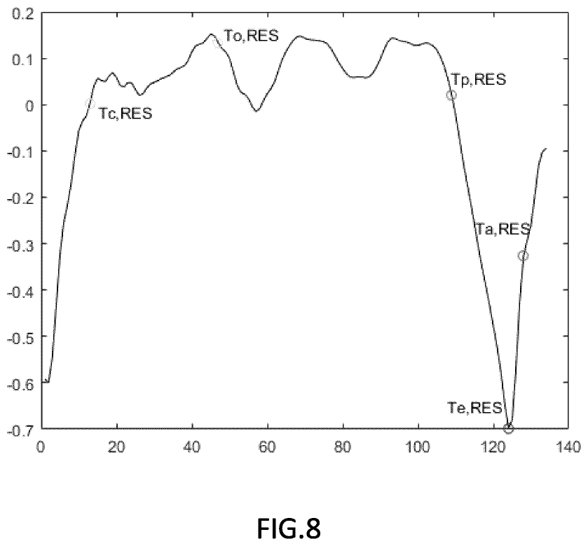

FIG. 8 illustrates examples of the LF-model parameters estimated from the speech signal using signal processing techniques. The Short-time segment of the glottal source derivative signal and the time-domain parameters of the LF-model are estimated from this signal using signal processing algorithms. The glottal source signal (also called residual) is calculated from the speech signal using a signal processing technique called inverse filtering.

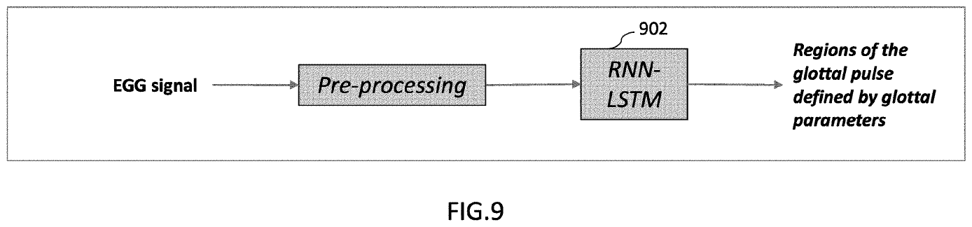

FIG. 9 illustrates an example of a neural network 902 that is trained to predict the regions of the glottal pulse (Open phase and Closed phase) defined by the parameters tₑ and tₒ of the LF-model. In this implementation, the neural network 902 is a Long short-term memory (LSTM) network. This is a type of Recurrent Neural Network (RNN) that is suitable for modelling time-dependencies of its input and can be trained to classify input signal regions and is a specific type of NN architecture.

It is to be noted that it is easier for the NN to model temporal regions (a sequence of points) than to represent a single point in the waveform. Also, the value of tₑ is the same as the duration Tₒₚ, because for generating the LF-model waveform we can consider tₒ to be equal to zero. The estimation of the closed phase duration permits to calculate a second parameter of the LF-model, T₀, which is calculated as the sum of the durations of the open phase and closing phase.

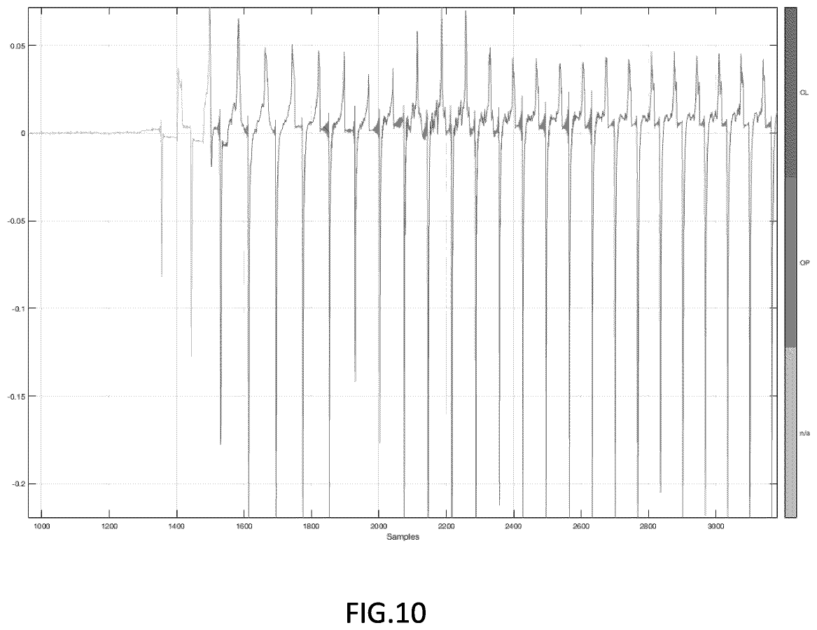

FIG. 10 illustrates an example of the input signal to the neural network 902, in accordance with an embodiment of the present invention. There is illustrated a segment of the derivative of the EGG signal (DEGG), and the labelled glottal pulse regions: Open phase (OP) with duration Tₒₚ and Closed phase (CL) with duration equal to T₀−Tₒₚ. The LSTM network 902 is trained to classify each sample of the input DEGG signal as being part of Open Phase (label ‘OP’), Closed Phase (label ‘CL’), or none of these phases (label ‘n/a’). The label ‘n/a’ is for the samples of EGG in which the glottal regions are not defined (for example, in silence regions). These labels are obtained from the DEGG signals of a training database by using signal processing algorithms followed by manual verification and correction.

The classification of the DEGG in one of: OP, CL and n/a categories is to estimate the parameters tₑ and T₀ of the LF-model as explained above. It is necessary to classify the label n/a because there are points in the signal that do not belong to the OP or CL regions. For example, points in the silence regions of speech sounds that are produced without vocal fold activity (they are not excited by airflow in the glottis) belong to regions labelled as n/a. Another example is that the glottal source wave flow does not exist in the speech production of many sounds, such as consonants (in this case the excitation of these speech sounds is represented by noise component only).

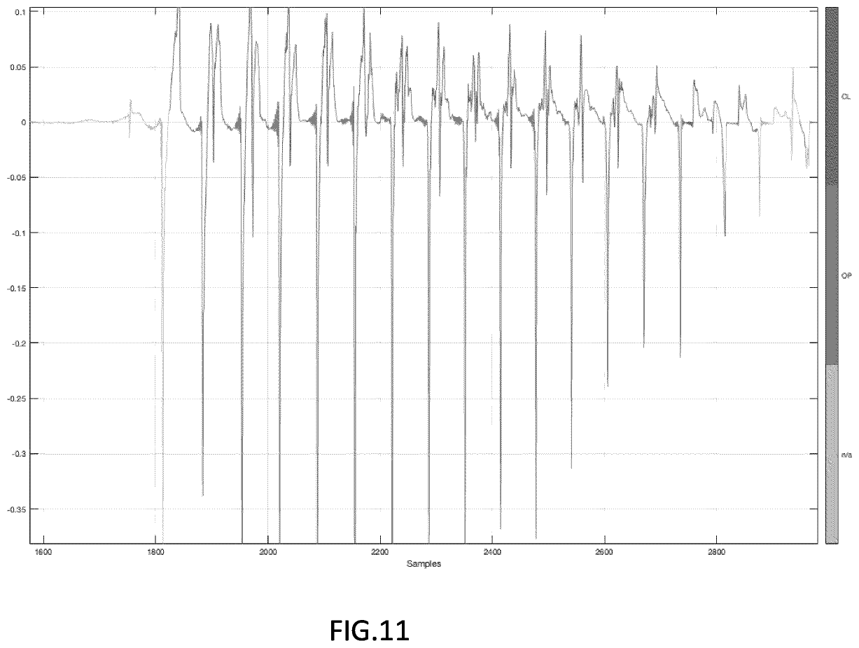

FIG. 11 shows an example of the DEGG waveform and the glottal phase parameters predicted by the neural network 902 after training. The advantage of using the LSTM network 902 to predict the glottal phase parameters is that it avoids the step of manual verification that is required when using signal processing technique, because the network 902 has been trained on good quality data that was obtained after manual verification and correction. Similar network models may be trained to estimate all the glottal parameters of the LF-model, either using the glottal source derivative signal, the DEGG signal or both.

Upon training, the RNN 902 may be used to estimate glottal parameters by using the same type of input signal representations that were used to train them. Thus, if the RNN 902 is trained successfully, it can estimate accurately glottal parameters for new data different from the training without the need for the human-in-the-loop. This process is much faster than the glottal parameter estimation that requires signal processing and human correction. Also, the RNN 902 can model non-linear characteristics of signals and solve complex estimation problems.

In the specification, the terms “comprise, comprises, comprised and comprising” or any variation thereof and the terms include, includes, included and including” or any variation thereof are considered to be interchangeable, and they should all be afforded the widest possible interpretation and vice versa.

The invention is not limited to the embodiments hereinbefore described but may be varied in both construction and detail.

1. A method for predicting acoustic features of an acoustic glottal source model, comprising:
extracting one or more acoustic features, including one or more glottal parameters, from an input signal containing information about glottal source signal, using a neural network (NN), wherein the NN is trained using one or more input signals, and previously estimated glottal parameters.

2. The method as claimed in claim 1, wherein the acoustic glottal source model is an Liljencrants-Fant model (LF-model), and the NN estimates one or more parameters defining the LF-model, and wherein the NN is trained to estimate durations of the input signal to enable determination of time domain parameters tₚ, tₑ, tₐ, t_{c}, T₀ of the LF-model.

3. The method as claimed in any preceding claim, wherein the input signal includes one of: a speech signal, a signal containing information about glottal source, an EGG signal, an estimate of the glottal source signal obtained from the speech signal by using an inverse filtering technique, an estimate of the glottal source signal obtained using a neural network, and an estimate of the glottal source signal obtained from an input text.

4. The method as claimed in any preceding claim further comprising extracting by the NN, a plurality of shape parameters Open Quotient (OQ), Speed Quotient (SQ), and Return Quotient (RQ) of the LF model from the input signal.

5. The method as claimed in claim 4 further comprising determining by the NN, one or more time-domain parameters of the LF-model tₐ, tₚ, tₑ, T₀ from the plurality of shape parameters, Open Quotient (OQ), Speed Quotient (SQ), and Return Quotient (RQ) based on the following equations:
$$OQ = \frac{{t}_{e} + {t}_{a}}{{T}_{0}}$$
$$SQ = \frac{{t}_{p}}{{t}_{e} - {t}_{p}}$$
$$RQ = \frac{{t}_{a}}{{T}_{0}}$$

6. The method as claimed in any preceding claim further comprising extracting by the NN, vocal tract (VT) parameters, and residual parts including noise and non-linear parameters from the input signal.

7. The method as claimed in any preceding claim further comprising synthesizing speech, using the estimated parameters of the acoustic glottal source model by first generating the glottal source waveform using the predicted glottal parameters, mixing the generated signal with a noise component generated by noise parameters and convolving the mixed-excitation signal with the VT transfer function defined by the VT parameters.

8. The method as claimed in claim 1, further comprising automatically diagnosing by the NN, speech disorders in a speech signal using the estimated glottal parameters.

9. The method as claimed in any preceding claim further comprising synthesizing speech, using the estimated glottal parameters as input to a neural vocoder that is trained to reconstruct a speech waveform from a set of speech features.

10. The method as claimed in any preceding claim, wherein glottal closure instant (GCI) parameter tₑ is estimated based on one or more lowest amplitude peaks of the derivative of the EGG signal using a peak detection algorithm.

11. The method as claimed in claim 10, wherein the pitch period T₀ is calculated as the duration between consecutive glottal closure instants tₑ of the derivative of the EGG signal.

12. The method as claimed in any preceding claim, wherein the NN is configured to synthesise speech from input text using the one or more glottal parameters, wherein the one or more glottal parameters condition the prediction of the speech waveform and transform one or more acoustic properties of the speech waveform.

13. A system for predicting acoustic features of an acoustic glottal source model, comprising:
a processing unit;
a non-transitory memory means operably coupled to the processing unit, the memory means has a plurality of instructions stored thereon which configures the processing unit to:
extract one or more acoustic features including glottal parameters from an input signal containing information about glottal source signal, using a neural network (NN), wherein the NN is trained using a plurality of input signals, and previously estimated glottal parameters.

14. The system as claimed in claim 13, wherein the acoustic glottal source model is an LF-model, and the NN estimates one or more parameters defining the LF-model, and wherein the NN is trained to estimate durations of the input signal to enable determination of time domain parameters tₚ, tₑ, tₐ, t_{c}, T₀ of the LF-model.
